(19) United States
(12) Patent Application Publication
(10) Pub. No.: US 2026/0332418 A1
(43) Pub. Date: Oct. 22, 2026

(54) TrustScore OS Auditable Importance Scoring with ZKP and TEE Attestations

(71) Applicant: Dario Chang, DORAL, FL (US)

(72) Inventor: Dario Chang, DORAL, FL (US)

(21) Appl. No.: 19/411,006

(22) Filed: Dec. 5, 2025

(51) Int. Cl. H04L 9/32

(52) U.S. Cl. CPC H04L 9/3221; H04L 9/3213

(57) ABSTRACT

TrustScore OS is a compliance-anchored platform that computes verifiable Importance Prediction Scores (IPS) by fusing cyclical engagement vectors with time-decayed historical influence vectors. The system embeds cryptographic compliance proofs, including zero-knowledge proofs and Trusted Execution Environment attestations, and issues machine-readable provenance tokens anchored to a tamper-evident ledger. It exposes privacy-preserving regulator APIs and standardized interoperability schemas for behavioral, emotional, and biological state representations. The platform integrates sustainability metrics, fairness auditing, human-in-the-loop governance, and programmable settlement mechanisms to enable regulator-aligned marketplace orchestration without disclosing raw personal data.

### FIELD

Computer-implemented systems and methods for computing session and asset importance scores, embedding cryptographic compliance proofs, issuing tamper-evident provenance tokens, exposing privacy-preserving regulator query interfaces, and orchestrating marketplace monetization and governance.

### CROSS REFERENCE

This application is a continuation-in-part of U.S. application Ser. No. 10/605,894 filed Nov. 4, 2003, incorporated by reference for Cycle Hits and Hits History.

### BACKGROUND

Modern platforms compute engagement and relevance metrics to drive ranking, pricing, and allocation decisions, but such metrics are often opaque, non-verifiable, and difficult to audit. Regulators and enterprise customers increasingly require verifiable proofs of algorithmic behavior, privacy protections, explainability, and sustainability reporting.

### Canonical Identifiers and Core Definitions

### Canonical Identifiers and Definitions

The following canonical identifiers and digest definitions are used throughout this specification.
ips_token_id—canonical serialized identifier for an IPS data structure. The canonical serialization is UTF-8 JSON with deterministic field ordering.
ips_token_digest—SHA-256 digest of the canonical serialized ips_token_id payload; used as the compact binding handle in proofs, attestations, and ledger anchoring.
proof_digest—SHA-256 digest of a published proof artifact (for example, a zkSNARK proof blob) stored in the Proof Registry.
attestation_ref—compact reference to an attestation token recorded in the tamper-evident ledger.
anchoring_ref—ledger transaction reference that stores a Merkle root computed over a batch of provenance tokens.
provenance_token—machine-readable object containing {ips_token_id; ips_token_digest; proof_digest; attestation_ref; sustainability_metrics; explainability_summary; provenance_confidence; anchoring_ref}.

### Cycle Hits and Hits History (Priority Support)

### Cycle Hits

Cycle Hits are periodic engagement vectors representing recurring interaction patterns within a session. Cycle Hits may be modeled using periodic basis functions such as sinusoidal, wavelet, or other periodic bases parameterized by session frequency and modality. This paragraph and the incorporated 2003 filing provide priority support for Cycle Hits.

### Hits History

Hits History represents time-decayed cumulative engagement across sessions. Hits History may be computed using exponential decay, sliding window averages, or other decay kernels parameterized by decay constant (λ) and modality weights. This paragraph and the incorporated 2003 filing provide priority support for Hits History.

### Parameterization

Parameterization includes modality weights, decay constants, window sizes, normalization factors, timestamp alignment, modality scaling, outlier rejection, and provenance tagging for each input event.

### IPS Fusion Engine and Multimodal Capture

### IPS Fusion Engine

The IPS fusion engine fuses Cycle Hits, Hits History, and multimodal inputs to produce a predictive Importance Prediction Score (IPS). Fusion embodiments include attention-weighted linear fusion, gating Mixture-of-Experts, sparse gating networks, and hybrid statistical-ML models. The IPS output includes a calibrated confidence interval and an explainable decomposition of contributions per modality and per component.

### Concrete IPS Issuance Flow (New Matter Supporting CIP Claims)

Step 1 Ingest—Event streams are normalized, timestamp aligned, provenance tagged, and privacy filters applied. Each event is mapped to a modality vector with modality weight (w_m).
Step 2 Cycle Hits—Compute Cycle Hits using periodic basis functions (e.g., s_k(t)=sin(2πf_k t+φ_k)), wavelet coefficients, or learned Neural Hawkes coefficients; output vector (C).
Step 3 Hits History—Compute Hits History using exponential decay (H_t=Σ_i e^{∧}(−λ(t−t_i)) h_i) or sliding window averages with window size (W).
Step 4 Fusion—Apply fusion operator F(C, H, M) where (M) are modality vectors; example: attention-weighted linear fusion (IPS=Σ_m α_m v_m) with α_m from softmax attention, or gated Mixture-of-Experts with sparsity regularizer. Fusion outputs ips_value, contributions[], and confidence_interval.

Step 5 IPS Data Structure—Assemble IPS data structure with fields {ips_token_id; ips_value; ips_version; timestamp; issuer_id; issuer_signature; ips_token_digest; confidence_interval; contributions; explainability_summary} and sign by issuer_id.

Step 6 Compliance Artifacts—(a) Generate a zkSNARK proof that the declared fusion operator (F) was applied to committed inputs producing ips_token_digest; publish proof_digest to a Proof Registry. (b) If executed in a TEE, produce an attestation_token binding ips_token_digest to enclave measurement and sign. (c) Record proof publication and attestation references in a tamper-evident ledger.

Step 7 Provenance Token Minting and Anchoring—Mint provenance_token containing the IPS data structure, proof_digest, attestation_ref, sustainability metrics, and provenance_confidence. Batch provenance tokens, compute Merkle root (R), publish ledger transaction containing (R), and return anchoring_ref.

Step 8 Regulator Query—Regulator interface authenticates auditor, enforces role-based permissions, and returns selective disclosures of provenance_token and Merkle proof paths via privacy-preserving API endpoints without transmitting raw personal data.

### Compliance Proofs and Secure Execution

Representative zkSNARK Circuit Sketch (New Matter)
Public Inputs—ips_token_digest, ips_version, issuer_id, timestamp, public_parameters (commitment keys).
Private Witness—committed modality vectors, Cycle Hits coefficients, Hits History values, fusion intermediate values, randomness used in commitments.
Constraints—arithmetic constraints verifying (1) commitments open to witness values; (2) fusion operator computation matches declared operator (F); (3) ips_value in ips_token_digest equals fused output.
Complexity Estimate—For N modality inputs and M fusion gates, constraint count O(N+M). Example: N=128, M=512 yields practical prover times and proof sizes; implementation examples provide measured runtimes and parameter tables.
Proof Publication—Prover publishes proof blob to Proof Registry; proof_digest recorded in provenance token and ledger.

### Trusted Execution Environment Attestation Token Format (New Matter)

Attestation Token Fields—attestation_id; enclave_measurement (e.g., MRENCLAVE); ips_token_digest; report_binding; signer_pubkey; timestamp; signature.
Attestation Generation Flow—TEE computes IPS inside enclave, computes ips_token_digest, produces attestation report including ips_token_digest, signs report with platform attestation key, and returns attestation_token.
Verification Flow—Verifier checks platform attestation chain, validates enclave_measurement against known good measurements, verifies signature, confirms ips_token_digest matches the provenance token, and records a signed verification receipt.

### Auditability Tokens and Merkle Anchoring

### Merkle Anchoring Flow (New Matter)

Leaf Hash—Each provenance token leaf hash L_i=SHA-256 (serialized_provenance_token_i).
Merkle Root—Compute Merkle root R=MerkleRoot(L_1, . . . , L_k).
Ledger Transaction Payload—{tx_id; ledger_timestamp; merkle_root: R; batch_size: k; issuer_id; signature}. The ledger returns anchoring_ref=tx_id.
Verification—Auditor receives provenance token and Merkle proof path; recomputes L_i and validates path to R referenced by anchoring_ref.
Privacy, differential privacy, and adversarial robustness

### Differential Privacy Worked Example (New Matter)

Example numeric tradeoff to support enablement:
Scenario—Tenant aggregates per-session click counts across 10,000 sessions; desired privacy parameters ε=0.5, δ=1×10^{∧}−6.
Noise Scale—Gaussian mechanism noise standard deviation σ≈√(2 ln(1.25/δ))/ε≈4.3.
Utility Impact—For mean session count 50, added noise standard deviation 4.3 yields relative RMSE≈8.6%; parameters are tunable per modality and tenant and example tables are provided.

### Adversarial Robustness

Periodic challenge/response tests and federated adversarial training under differential privacy generate adversarial robustness attestations; IPS recalibration is triggered when attestations indicate model drift or vulnerability.

Regulator APIs, interoperability, and governance

### Regulator API Example (New Matter)

Endpoint GET/api/v1/provenance/{ips_token_id} with auditor JWT and auditor public key reference.

Response JSON includes {provenance_token, merkle_proof, verifier_receipt} where provenance_token contains ips_token_id, ips_value, timestamp, issuer_id, proof_digest, attestation_ref, anchoring_ref, sustainability_metrics, explainability_summary, and provenance_confidence.

Selective Disclosure—Field-level selective disclosure is supported using cryptographic commitments and zero-knowledge selective disclosure techniques so auditors can validate proofs without receiving raw inputs.

Access Controls—APIs enforce role-based permissions, cryptographic auditor authentication, query rate limits, and log each auditor query as a tamper-evident artifact.

### Governance and Fairness

Governance layer enforces bias auditing, fairness scoring, and human-in-the-loop gating for high-value transactions. Fairness auditors compute counterfactual removal tests, distributional parity checks, and feature-attribution explainability (e.g., SHAP, LIME). Human approvals are recorded in provenance tokens with approver identity, timestamp, and cryptographic commitments.

### Marketplace Orchestration and Tokenization

### Dynamic Pricing Orchestrator

Reinforcement learning agents compute transaction prices conditioned on IPS values, sustainability metrics, and fairness scores. Orchestrator supports on-chain and off-chain settlement rails and programmable settlement via smart contracts.

### Tokenization Engine

Mint consent-scoped tokens representing emotional or biological state indices conditioned on IPS values and provenance proofs; tokens include settlement rules and provenance references and support programmable settlement across fiat rails, stablecoins, and CBDC rails.

### Sustainability Optimizer

Per-session energy accounting and carbon intensity metrics feed into workload placement and pricing decisions; optimizer favors lower carbon nodes when IPS deltas are within configurable tolerances.

### Implementation Examples and Pseudocode

Representative Pseudocode Excerpts (new matter) computeIPS pseudocode: ingest→normalize→compute Cycle Hits and Hits History→fuse→assemble IPS→compute ips_token_digest→sign.

Generateproofandattestation Pseudocode:

zkProver.generate(public_inputs=[ips_token_digest], witness)→proof_digest→publishProof; if in TEE then TEE.generateAttestation(ips_token_digest)→recordAttestation. mintProvenanceToken pseudocode: assemble provenance→leaf=SHA-256 (serialized_provenance)→add to batch→when batch ready compute Merkle root→ledger.publish→anchoring_ref.

### Cryptographic Parameters

Example recommended primitives: SHA-256 for hashing; Pedersen commitments for commitments; ECDSA over secp256r1 or BLS12-381 for signatures; zkSNARK families Groth16 or PLONK-style constructions as non-limiting examples.

### Enablement and Claim Support

### Enablement

Implementation examples, parameter ranges, measured proof generation times, and sample payloads are provided to enable a person skilled in the art to implement the claimed systems and to support § 112 written description and enablement requirements for the CIP claims.

### Claim Support Mapping

The specification provides paragraph-level support for claims reciting Cycle Hits, Hits History, IPS fusion, zkSNARK proofs, TEE attestations, provenance tokens, Merkle anchoring, regulator APIs, sustainability metrics, and tokenization. Paragraphs [0026]-[0028] are supported by the 2003 priority filing; paragraphs labeled as new matter (for example, [0034], [0041], [0042], [0046], [0036], [0052], [0078]) are CIP additions and have the current filing date.

### Conclusion

The specification supports prosecution of claims directed to compliance-anchored IPS platforms and provides a foundation for continuations that add further concrete cryptographic, TEE, ledger, and API embodiments.

### Statement of Technical Advantages and Commercial Relevance

The disclosed TrustScore OS architecture provides a unified compliance-anchored scoring framework that materially improves over prior art by combining: (i) early priority scoring concepts (Cycle Hits and Hits History) with modern fusion operators; (ii) cryptographic compliance artifacts (zkSNARK proofs and TEE attestations) that verifiably bind IPS outputs to secure execution; (iii) tamper-evident provenance tokens anchored via Merkle roots; (iv) regulator-facing APIs that enable selective disclosure without raw data exposure; and (v) integrated sustainability metrics, fairness auditing, and programmable settlement. This combination yields a practical, regulator-aligned platform that addresses transparency, privacy, and ESG requirements in digital marketplaces. The architecture is designed to maximize licensing and enforcement value by providing defensible technical hooks that distinguish over existing CTR prediction and compliance scoring systems. Accordingly, the invention offers both technical novelty and commercial leverage, supporting examiner review and future continuation filings.

### Claim-to-Advantage Mapping Table (Non-Limiting)

This table illustrates how each claim corresponds to specific technical advantages described in the specification. It is provided to assist examiners in understanding the practical improvements and commercial relevance of the invention. The claims are supported by the entire disclosure, and this table is not intended to limit claim scope.

The foregoing description, advantages, and mapping are illustrative and non-limiting. The scope of the invention is defined by the appended claims.

What is claimed is:

1. A computer-implemented system for predictive scoring and compliance-anchored orchestration, comprising:
a prediction engine executing on one or more processors and configured to:
(i) ingest event streams and generate cyclical engagement vectors and time-decayed historical influence vectors; and
(ii) fuse the cyclical engagement vectors and the historical influence vectors to produce an Importance Prediction Score (IPS) data structure comprising fields {IPS_value; IPS_version; timestamp; issuer_id; issuer_signature; ips_token_digest};
a compliance module configured to generate a succinct cryptographic proof and a Trusted Execution Environment (TEE) attestation bound to the IPS data structure and to publish a proof_digest;
a provenance token generator configured to mint a machine-readable provenance token comprising the IPS data structure, the proof_digest, and an anchoring_ref referencing a tamper-evident ledger entry; and
a regulator interface configured to respond to authenticated auditor queries by returning selective disclosures of the provenance token via privacy-preserving APIs without transmitting raw personal data.

2. The system of claim 1, wherein the prediction engine is further configured to compute cyclical engagement vectors using sinusoidal, wavelet, or Neural Hawkes basis functions parameterized by session frequency and modality, and to compute historical influence vectors using exponential decay or sliding window kernels parameterized by a decay constant (λ).

3. The system of claim 1, wherein the compliance module is configured to produce a zero-knowledge succinct noninteractive argument of knowledge (zkSNARK) proof that the declared fusion operator was applied to committed inputs to produce the IPS, and to publish the proof_digest to a Proof Registry.

4. The system of claim 1, wherein the provenance token further includes sustainability metrics comprising per-session energy consumption and carbon intensity and a provenance_confidence score, and wherein the provenance token is anchored to the ledger by storing a Merkle root and returning an anchoring_ref.

5. The system of claim 1, wherein, upon successful verification of the IPS data structure and associated compliance proof, the system automatically performs a machine-state enforcement action comprising revoking or suspending an access token, updating an asset state to UNLISTED, emitting a signed state envelope, and writing the signed state envelope to the tamper-evident ledger.

6. The system of claim 1, wherein sensitive IPS computations execute within a Trusted Execution Environment that produces an attestation token comprising enclave measurement, a report binding to ips_token_digest, signer public key, timestamp, and signature, and wherein the attestation token is recorded in the tamper-evident ledger.

7. The system of claim 1, wherein the regulator interface enforces role-based permissions, cryptographic auditor authentication, and privacy-preserving query mechanisms, and logs each auditor query as a tamper-evident artifact comprising a query identifier, verifier signature, timestamp, and auditor public key reference.

8. The system of claim 1, wherein the provenance token generator constructs the anchoring_ref by computing a Merkle root over a batch of provenance tokens and storing the Merkle root in a ledger transaction, and wherein the regulator interface verifies token anchoring by validating a Merkle proof against the stored Merkle root.

9. A computer-implemented method for predictive scoring and compliance-anchored orchestration, comprising:
ingesting event streams and generating cyclical engagement vectors and time-decayed historical influence vectors;
fusing the cyclical engagement vectors and the historical influence vectors to produce an IPS data structure with calibrated confidence intervals;
generating a cryptographic compliance proof and a TEE attestation bound to the IPS data structure and publishing a proof_digest;
minting a provenance token comprising the IPS data structure, the proof_digest, and an anchoring_ref;
exposing selective disclosures of the provenance token to authenticated auditors via a privacy-preserving API without disclosing raw personal data; and
upon verification of the IPS and compliance proof, automatically performing a machine-state enforcement action and recording the enforcement action in a tamper-evident ledger.

10. The method of claim 9, wherein fusing comprises applying an attention-weighted linear fusion or a gated Mixture-of-Experts fusion head and producing an IPS packet that includes explainability decomposition and provenance pointers.

11. The method of claim 9, wherein calibrated confidence intervals are computed using conformal prediction or Bayesian ensembling and are recorded in the IPS data structure.

12. A platform for predictive scoring and marketplace orchestration, comprising:
a dynamic pricing orchestrator configured to compute transaction prices using reinforcement learning agents conditioned on IPS values and sustainability metrics;
a governance layer configured to enforce bias auditing, fairness scoring, and human-in-the-loop gating for high-value transactions;
interoperability APIs configured to enable third-party marketplaces to integrate IPS tokens and provenance proofs; and
a tokenization engine configured to mint consent-scoped tokens representing emotional or biological state indices conditioned on IPS values and provenance proofs and to enforce programmable settlement across on-chain and off-chain rails.

13. The platform of claim 12, wherein fairness scores are computed using counterfactual removal tests, distributional parity checks, and feature-attribution methods, and wherein actions that fail fairness thresholds are routed to human review.

14. The platform of claim 12, wherein the tokenization engine supports programmable settlement via smart contracts and records settlement events and remediation playbooks in the tamper-evident ledger.

15. The platform of claim 12, wherein the interoperability APIs expose OpenAPI and JSON Schema descriptors for proof verification, attestation verification, token lookup, and regulator queries.

16. The system of claim 1, wherein the interoperability schema includes canonical emotional state fields comprising valence, arousal, dominance, and confidence, and wherein biological indices are included only upon presentation of a valid consent token and selective disclosure via cryptographic proofs.

17. The method of claim 9, wherein adversarial robustness is assessed by periodic challenge/response tests and federated adversarial training under differential privacy, and wherein IPS values are recalibrated based on adversarial robustness attestations.

18. The system of claim 1, wherein the compliance module records proof publication events and verifier receipts in the tamper-evident ledger and provides a Verifier API that returns a signed verification receipt upon validation of a proof_digest.

19. The system of claim 1, wherein human approvals required by governance are recorded in provenance tokens and include approver identity, timestamp, and a cryptographic commitment linking the approval to the IPS token digest.

20. The system of claim 1, wherein sustainability optimization adjusts workload placement and pricing based on carbon intensity APIs and ESG scoring and favors lower carbon nodes when IPS deltas are within a configurable tolerance.
